(19) United States
(12) Patent Application Publication
(10) Pub. No.: US 2005/0266144 A1
(43) Pub. Date: Dec. 1, 2005

(54) Parfried frozen french fry having high solids content

(75) Inventors: Michael L. Hamann, Caldwell, ID (US); Stephen L. O'Bannon, Caldwell, ID (US)

Correspondence Address: KELLY LOWRY & KELLEY, LLP, 6320 CANOGA AVENUE, SUITE 1650, WOODLAND HILLS, CA, 91367, US

(73) Assignee: J.R. SIMPLOT COMPANY

(21) Appl. No.: 11/112,263

(22) Filed: Apr. 21, 2005

Related U.S. Application Data
(60) Provisional application No. 60/576,221, filed on Jun. 1, 2004.

(51) Int. Cl. A23L 1/00

(52) U.S. Cl. 426/637

(57) ABSTRACT

Improved parfried and frozen French fry potato strips and a related production process are provided, wherein the French fry strips exhibit a relatively high solids content and a correspondingly low moisture content in the parfried frozen state. Elongated cut French fry strips are initially blanched and then subjected to an extended dry step for removing moisture therefrom. Following the dry step, the potato strips are partially rehydrated by contacting the external surfaces thereof with a moisture-laden agent such as a batter coating, followed by a single parfry step and prompt freezing. The parfried frozen potato strips exhibit a high solids content on the order of about 33-42%. These high solids strips can be finish prepared by finish frying, or by alternative methods such as heating in a convection oven, with the finish prepared potato strips exhibiting a desirable set of taste, texture and color attributes.

This application claims the benefit of U.S. Provisional Application 60/576,221, filed Jun. 1, 2004.

### BACKGROUND OF THE INVENTION

This invention relates generally to processes for preparing parfried and frozen potato strips such as elongated French fry strips. More specifically, this invention relates to an improved process and the resultant prepared potato strips which have a relatively high solids content, and a correspondingly low moisture content in a frozen state following a single parfry step. These high solids potato strips are adapted for reconstitution or finish preparation in an oven, or alternately by means of rapid finish fry preparation, with a highly desirable combination of taste, appearance and textural characteristics.

Parfried and frozen potato strips, commonly referred to as French fries, are widely available in the foods industry. These potato products are conventionally prepared by cutting whole potatoes into elongated strips of a desired size and shape, and then partially cooking the potato strips by blanching in hot water or steam. Thereafter, the potato strips are partially fried, or parfried, in hot cooking oil, followed by freezing for packaging, shipping and/or storage. Prior to consumption, the parfried and frozen potato strips are reconstituted or finish prepared typically by finish frying in hot oil. French fried potato strips of this type are utilized extensively in restaurant and food service operations, and particularly in so-called fast food restaurants wherein it is desirable to produce a finish cooked product with a substantially optimized set of quality characteristics and with a relatively short finish fry preparation time.

More specifically, one major objective of potato processors is to provide parfried and frozen potato strips which can be finish prepared with a combination of taste, color, odor, and textural attributes selected for substantially optimum consumer palatibility. For example, it is highly desirable to provide parfried and frozen potato strips which, after finish preparation, exhibit a light and tender but crispy exterior surface of golden brown fried color encasing a soft and mealy interior which is neither too dry nor too soggy. Moreover, especially in a fast food restaurant environment, it is important to provide finish cooked potato strips which can consistently retain these desired sensory qualities for an extended holding period of at least several minutes before actual consumption. In the past, achieving these desirable product qualities on a consistent basis has generally required that the potato strips be finish prepared by frying in hot oil. In a fast food establishment, to avoid advance preparation of potato strips that might not be sold or served within a limited holding time of several minutes, a relatively short finish fry step is desired and is typically on the order of about 2-3.25 minutes for smaller so-called shoestring size cut strips and about 3-4 minutes for larger strips cut sizes.

In recent years, alternative finish preparation methods such as oven heating have been researched in an attempt to eliminate the need to finish fry potato strips at the restaurant or food service facility. In this regard, traditional finish fry preparation methods have required specialized or dedicated frying equipment which must be maintained in a clean and sanitary condition. Moreover, finish frying steps inherently require the food service facility to use and handle significant amounts of cooking oil, with its associated cost and increasingly complex issues of used oil disposal. Further, there is an increased demand among health conscious consumers for food products having a reduced oil or fat content, whereby there is a growing demand for potato strips which are not finish prepared by frying. While these factors all contribute to an increasing interest in potato strips which have been finish prepared by means other than frying, the final product served to the consumer must exhibit a substantially optimized set of taste, appearance and textural characteristics similar to a conventional finish fried product in order to achieve consumer acceptance.

Oven finish preparation of parfried and frozen potato strips has generally involved significant modifications to the parfry preparation steps in order to provide French fry strips suitable for oven reconstitution. Specifically, parfried and frozen potato strips intended for oven finishing are typically processed to a strip moisture content which is lower than the moisture content of conventional parfried and frozen strips intended for finish preparation by frying. For example, conventional frozen French fry strips suitable for finish frying are typically parfried to a moisture content in the range of about 60-70% by weight. When such potato strips intended for finish fry preparation are instead finish prepared by oven heating, the reconstituted French fry strips are undesirably limp and soggy unless subjected to an extended oven heating cycle in which case the strips become excessively dry and tough. Conversely, frozen French fry strips designed for finish preparation by oven heating are normally parfried to a lower moisture content in the range of about 35-55%, and more preferably in the range of about 40-52%, and most preferably about 44-50% by weight. This reduced moisture content may be obtained by subjecting the potato strips to at least two parfry steps with an intermediate chilling or freezing step, prior to final freezing. Such high solids, reduced moisture strips can be finish prepared in an air impingement oven, a convection oven, a conventional oven, or a microwave oven, yet retain a desirable crisp exterior encasing a soft and mealy interior. It has also been recognized that such reduced moisture strips can be finish prepared by frying with a rapid, significantly shortened finish fry preparation time. See, for example, U.S. Pat. No. 4,590,080. However, the dual parfry steps inherently result in increased potato strip production cost, as well as increased absorption of oil thereby increasing the level of fat in the parfried frozen strips.

Alternative production methods using a single parfry step to achieve a high solids, low moisture product in the parfried frozen state have generally been unsuccessful to date. In this regard, increased moisture reduction by means of an extended single parfry step has not produced French fry strips which can be finish prepared by non-fry alternative methods such as oven heating. Attempts to reduce strip moisture content by increasing the time and/or temperature conditions of a pre-parfry dry step have produced French fry strips that are undesirably leathery and tough following finish preparation.

There exists, therefore, an on-going need for further improvements in and to French fry potato strip preparation processes and the resultant products, particularly with respect to providing a relatively high solids and correspondingly low moisture frozen product that has been subjected to a single parfry step, and is adapted for finish preparation by alternative means such as short-cycle rapid finish frying or by oven heating (from frozen or refrigerated product state) to produce a finish product exhibiting a substantially optimized set of taste, texture and appearance characteristics. The present invention fulfills these criteria and provides further related advantages.

### SUMMARY OF THE INVENTION

In accordance with the invention, improved parfried and frozen French fry potato strips and a related production process are provided, wherein the French fry strips exhibit a relatively high solids content and a correspondingly low moisture content in the parfried frozen state. These parfried frozen potato strips are adapted for finish preparation by alternative methods such as rapid or short-cycle finish fry preparation, or alternately by means of oven heating in an air impingement, convection, conventional or microwave oven or the like, to produce finish prepared strips having a highly desirable and substantially optimized balance of taste, texture and appearance traits.

Elongated French fry strips are cut from raw potatoes having an initial solids content of about 20-22% by weight, and then blanched or partially cooked in hot water or steam. The blanched strips are then subjected to an extended or prolonged dry step for removing moisture therefrom. In one preferred process, the blanched strips are subjected to a flow of warm air at a temperature of about 150° F. for about 8-10 minutes, to achieve a solids content of about 25% by weight upon exiting the dry step. Following this dry step, the potato strips are partially rehydrated as by contacting the external surfaces thereof with a moisture-laden agent, such as a clear coat batter coating having a moisture or water content of about 60% by weight, particularly such as the clear coat batter disclosed in U.S. Pat. No. 6,132,785 which is incorporated by reference herein. The thus partially rehydrated potato strips exhibit a solids content of about 26-29% by weight.

Following the extended dry step and batter coating step, the potato strips are subject to a single parfry step in hot oil, such as a vegetable or canola oil, to produce a high solids and low moisture product having a solids content on the order of about 40-42% by weight. In one preferred process, the strips are parfried in canola oil at a temperature of about 385° F. for about 65-70 seconds, to produce a parfried product having a solids content of about 33-41% by weight (depending upon the raw cut size of the strips; 33% for large cuts such as 10 cut wedges and 41% for standard shoestring cut French fries). These parfried strips are then promptly frozen as by blast freezing at a temperature of about −20° F. followed by packaging for shipment and/or frozen storage.

The thus-prepared parfried and frozen potato strips are suitable for finish preparation by alternative means such as finish frying or oven heating. For example, the strips can be finish fried in a relatively fast-cycle finish preparation step as by frying in hot oil at a temperature of about 350° F. for about 105 seconds. Alternately, the strips can be heated in a forced air convection oven at a temperature of about 400° F. for about 6 minutes. In either finish preparation method, the finished strips exhibit a highly desirable set of taste, texture and appearance characteristics closely emulating the characteristics of conventional lower-solids parfried frozen potato strips strips which have been finish prepared by a conventional finish fry step.

Other features and advantages of the invention will become more apparent from the following detailed description.

### DETAILED DESCRIPTION OF THE PREFERRED EMBODIMENT

The present invention relates to improved parfried and frozen potato strips having a relatively high solids content and a correspondingly low moisture content, and a related production process, wherein the potato strips are subjected to a single parfry step, and further wherein the parfried frozen strips are suitable for finish preparation by fast-cycle finish frying or by oven heating. When finish prepared, the French fry potato strips exhibit a combination of highly desirable, substantially optimized taste, texture and appearance characteristics.

French fry potato strips are conventionally prepared by cutting whole potatoes in a raw and typically peeled state into elongated strips having selected and typically rectangular cross sectional dimensions and a selected length distribution range. For example, traditional so-called shoestring cut French fry potato strips as used widely in fast food restaurants have a generally square cross sectional shape with each side measuring about 0.3 inches in width, and a length distribution ranging from about 2-6 inches. French fry potato strips of this cut style are typically processed to a parfried and frozen state for packaging and shipment to a food service facility where they are normally finished prepared by frying in hot oil immediately prior to serving to consumers. In this regard, over a period of years, consumers have learned to recognize and expect such French fry potato strips to exhibit a certain set of taste, texture, color, and other quality characteristics, such as a light and tender but crispy exterior surface encasing a soft and mealy interior which is neither too dry nor too soggy.

Parfried and frozen potato strips are conventionally processed at a production facility by subjecting the raw cut strips to an initial partial cooking step such as blanching in hot water or steam. The blanched strips are then drained of excess water and, in accordance with one preferred process as described in U.S. Pat. No. 3,397,993, subjected to a brief drying step for controlled reduction in strip moisture content. In many processes, prior to the drying step, the strips are dipped into or sprayed with a dextrose-based solution which may also include sodium acid pyrophosphate (SAPP) for enhanced browning color development during subsequent frying. In some processes, the potato strips are also surface-coated as by dipping or spraying with a batter typically such as an aqueous starch based batter composition. The potato strips are parfried in hot oil followed by freezing and packaging for shipment and/or storage. In this regard, it is not uncommon for the parfried and frozen potato strips to be retained in a frozen state for several weeks prior to finish preparation at a restaurant facility of the like for serving to consumers. For potato strips intended for conventional finish preparation by finish frying in hot oil, the strips typically exhibit a moisture content of about 60%-70% by weight in the parfried and frozen state. Such potato strips are exemplified by those available at McDonald's restaurants.

In recent years, parfried and frozen French fry potato strips have been developed for finish preparation by oven heating, such as by heating in an air impingement oven, a convection oven, a conventional oven, or a microwave oven. To provide an oven-finished product which exhibits desirable external crispness, without excessive limpness and sogginess, the parfried and frozen strips are normally processed to a comparatively lower moisture content, typically in the range of about 35%-55% by weight, and more preferably about 40%-52% by weight, and most preferably about 44%-50% by weight. In addition, it has been recognized that such low moisture parfried and frozen potato strips are also suitable for rapid finish fry preparation, with a significantly faster finish fry step in comparison with finish frying of conventional higher moisture frozen parfried strips. In the past, such relatively low moisture frozen parfried potato strips have been produced by subjecting the strips to a pair of parfry steps with an intervening cooling or freezing step, prior to final freezing. See, for example, U.S. Pat. No. 4,590,080, which is incorporated by reference herein. However, such dual-parfry process inherently increases the production costs. In addition, the twice-parfried potato strips are subjected to the parfry oil for a longer period of time, whereby the strips absorb more cooking oil and thereby exhibit a higher fat content, in comparison with potato strips that have been subjected to a single parfry step.

By contrast, prior attempts to produce relative higher solids, low moisture French fry potato strips by the use of a single parfry step have generally not met with success. Such single-parfry processes have generally relied upon an extended parfry time and/or increased parfry temperature to increase potato strip moisture loss. Alternately, or in combination, single-parfry processes have utilized an extended pre-parfry dry step by increasing the dry time and/or temperature conditions, but such techniques have heretofore produced French fry strips that are undesirably leathery and tough following finish preparation.

The present invention relates specifically to improved high solids, low moisture French fried potato strips suitable for finish preparation in an oven, or alternately for rapid finish fry preparation, wherein the improved potato strips are produced by a preparation process including a single parfry step. More particularly, fresh cut potato strips are initially blanched in steam or hot water, and then subjected to an extended dry step for substantially reducing product moisture level. In accordance with a primary aspect of the invention, the dried potato strips are then partially rehydrated by contacting the exterior strip surfaces with a rehydrating agent such as an aqueous-based clear coat batter or the like. Alternately, the rehydrating agent may comprise a suitable wetting solution such as a water-based dip or spray. The partially rehydrated potato strips are then subjected to a single parfry step, followed by prompt freezing for shipment and/or storage awaiting finish preparation. These parfried frozen potato strips exhibit a relatively high solids content, and a comparatively low moisture content. Upon finish preparation as by rapid-cycle finish frying or by oven heating, the potato strips exhibit a highly desirable set of taste, texture and appearance traits.

In one preferred and exemplary form of the invention, elongated shoestring size potato strips are cut to a desired size and shape from raw whole peeled and trimmed potatoes, such as Russet Burbank, Shepody, or other potato varieties used commonly in the production of parfried and frozen French fry potato strips. Specifically, these potatoes are cut into strips of generally square cross sectional shape with the width of each cut strip side on the order of about 0.29-0.30 inch. The lengths of the cut potato strips vary according to the size of the potatoes being cut, with a typical length ranging from about 1 inch to about 6 inches. The cut strips prepared as described desirably have a length distribution of at least about 30% having a length exceeding three inches, and not more than about 20% having a length less than two inches. These raw potato strips have a solids content on the order of about 20-22% by weight, and thus a corresponding moisture content on the order of about 78-80% by weight.

These raw-cut shoestring potato strips are partially cooked by water blanching in hot water or steam, such as blanching at approximately 155-200° F. for about 2-15 minutes. In one example, the cut potato strips are blanched in hot water at about 170° F. for about 4-5 minutes, and then blanched a second time in hot water at about 180° F. for about 3-4 minutes, with the blanch times and/or blanch temperatures adjusted appropriately so that the blanched strips have a reduced level of dextrose and an even and acceptable texture.

Following these water blanch steps, the strips are dipped briefly into a water-based dip solution having a temperature of about 160° F. for about 30 seconds, wherein this dip solution has a pH on the order of about 7.5-8.2, and preferably about 7.8. One preferred dip solution includes about 0.3% weight dextrose, about 1.0% weight salt, about 0.4% weight sodium acid pyrophosphate (SAPP), about 1.2% weight tetra sodium pyrophosphate (TSPP). The specific pH tends to support fry strip texturization and conditioning that facilitates later drying and batter coating process steps.

The thus-treated blanched and dipped potato strips are then subjected to the extended dry step to achieve a strip weight loss on the order of about 7-10%. For a standard clear coat batter system, the strip weight loss would be in the 7-12% range and the solids content of these dried strips in the range of 21-23% (depending upon beginning raw solids. In a preferred process, the strips are subjected to a flow of warm air at a temperature of about 150° F. for about 5-15 minutes, resulting in partially dried potato strips having a solids content of about 24-27% by weight.

The partially dried potato strips are then partially rehydrated by application of the moisture-laden rehydrating agent as by dipping or spraying. In accordance with the preferred process of the invention, the potato drips were surface-coated with a thin film of a clear coat starch-based batter having a solids content of about 40% by weight, such as a clear coat batter of the type disclosed in U.S. Pat. No. 6,132,785 which is incorporated by reference herein. Alternative starch-based batters may used, including batters having modified food starch, corn starch, potato starch, and/or rice starch and the like as batter constituents. The thus partially rehydrated potato strips exhibit a solids content of about 26-29% by weight. Alternative rehydrating agents may include water or water-based solutions containing available free water capable of rehydrating the partially dried strip surface applied to the exterior surfaces of the strips as by dipping or spraying. Typical batter or water weight gain ranges from 8-19%.

The partially rehydrated strips are then subjected to a single parfry step in hot oil, at a substantially normal oil temperature and an extended parfry time when compared with standard single-parfry French fry products. In the preferred form, the rehydrated potato strips are parfried in canola oil or the like, at a temperature of about 385° F. and a time of about 65-75 seconds. The thus-parfried potato strips have a solids content of about 40-42% by weight, and a corresponding moisture content of about 58-60% by weight. These potato strips are promptly frozen as by blast freezing at a temperature of about −15 to about −20° F., followed in turn by appropriate packaging for shipment and/or storage.

It will be recognized and understood by persons skilled in the art that the cooking oil may comprise any of a wide range of natural and synthetic fats or oils consisting essentially of triglycerides, as well as non-toxic fat-like materials having properties similar to triglycerides and commonly referred to as fat substitutes which may be fully or partly indigestible. Non-digestible cooking oils are identified in more detail in U.S. Pat. No. 6,001,411.

For oven finish preparation, the parfried and frozen potato strips are reconstituted in an oven, such as a forced air institutional convection oven or a double air impingement oven of the type having vertically opposed upwardly and downwardly directed jets of substantially collimated and heated air aimed toward a moving belt for transporting the potato strips through the oven. More particularly, the potato strips are placed while frozen in a relatively shallow layer, preferably having a bed depth not to exceed about one inch, directly onto the moving belt or onto a shallow tray or pan formed from a relatively high thermal heat transfer material, and exposed within the oven to the opposed heated air jets directed substantially perpendicular to the layer of strips. In an exemplary double air impingement oven, such air jets provide a relatively combined high mass flow on the order of about 1000-4000 cubic feet per minute (cfm), and preferably on the order of about 1100-2500 cfm. The potato strips are heated within a standard institutional convection oven at a temperature of about 400° F. for a short finish preparation time of about 6 minutes. The oven-finished French fry strips were then lightly salted and ready for immediate consumption.

Exemplary forced air institutional impingement ovens of the general type referenced above are disclosed, for example, in U.S. Pat. Nos. 4,338,911 and 4,523,391. Such ovens are available commercially from Lincoln Foodservice Products, Inc. of Fort Wayne, Ind., under the product designation Impinger II, and/or from Middle by Cooking Systems Group of Elgin, Ill., under the product designation Rofry.

In the finished form, these oven-heated potato strips exhibit a desirable and substantially optimized blend of taste, texture and appearance characteristics closely emulating the traits of conventional single-parfried and frozen potato strips which have been finish prepared by frying.

For rapid finish fry preparation, the parfried frozen potato strips are finish fried in hot oil, such as canola oil or the like of the type used in the parfry step, for a finish fry cycle time on the order of about 100-110 seconds, at a finish fry temperature of about 350° F. The thus finish-fried strips are removed from the hot oil, briefly drained, and then lightly salted preparatory to immediate serving to the consumer.

In the finish fried form, the potato strips of the present invention also exhibit a desirable and substantially optimized blend of taste, texture and appearance characteristics closely emulating the traits of conventional lower-solids, single-parfried and frozen potato strips which have been finish prepared by frying.

A variety of further modifications and improvements in and to the improved high solids, low moisture potato strips and related preparation process of the present invention will be apparent to those skilled in the art. Accordingly, no limitation on the invention is intended by way of the foregoing description, except as set forth in the appended claims.

1. A process for parfrying and freezing potato strips capable of subsequent finish preparation by alternative methods including finish frying and oven heating, comprising the steps of:
blanching the potato strips in hot water or steam;
drying the blanched potato strips to a solids content of about 24% to about 27% by weight;
partially rehydrating the dried potato strips by contacting the external surfaces thereof with a moisture-laden agent, the partially rehydrated potato strips having a solids content of about 26% to about 29% by weight;
parfrying the rehydrated potato strips in hot oil for a single parfry step, the once-parfried strips having a solids content of about 33% to about 42% by weight; and
freezing the once-parfried potato strips.

2. The process of claim 1 further including the step of cutting the potato strips from raw potatoes, the cut strips having a generally square cross sectional shape with the wide side of each cut strip on the order of about 0.30 inch, and the cut strips having lengths ranging from about 1 inch to about 6 inches, the cut strips having a solids content in the raw state of about 20% to about 22% by weight.

3. The process of claim 1 wherein said blanching step comprises blanching the potato strips in hot water at about 155° F. to about 200° F. for about 2-15 minutes.

4. The process of claim 1 wherein said blanching step comprises blanching the potato strips in hot water at about 170° F. for about 4-5 minutes, and then blanching the potato strips a second time in hot water at about 180° F. for about 3-4 minutes.

5. The process of claim 1 further including the step of dipping the blanched potato strips into a dextrose dip solution prior to said drying step.

6. The process of claim 5 wherein said dipping step comprises dipping the blanched potato strips into the dextrose dip solution having a temperature of about 160° F. for about 30 seconds, and wherein the dip solution has a pH on the order of about 7.5-8.2.

7. The process of claim 6 wherein the dextrose dip solution includes about 0.3% weight dextrose, about 1.0% weight salt, about 0.4% weight sodium acid pyrophosphate (SAPP), about 1.2% weight tetra sodium pyrophosphate (TSPP).

8. The process of claim 1 wherein said drying step comprises drying the blanched potato strips to achieve a strip weight loss on the order of about 7-12%.

9. The process of claim 1 wherein said drying step comprises subjecting the blanched potato strips to a flow of warm air at a temperature of about 150° F. for about 5-15 minutes.

10. The process of claim 1 wherein said rehydrating step comprises applying the moisture-laden agent by dipping or spraying.

11. The process of claim 1 wherein the moisture-laden agent comprises an aqueous batter.

12. The process of claim 1 wherein the moisture-laden agent comprises a starch-based batter having a solids content of about 40% by weight.

13. The process of claim 1 wherein the moisture-laden agent comprises water.

14. The process of claim 1 wherein the rehydrated potato strips exhibit a weight gain ranging from about 8% to about 19% by weight, attributable to the moisture-laden agent.

15. The process of claim 1 wherein said parfrying step comprises parfrying the rehydrated potato strips in hot oil at a temperature of about 385° F. and a time of about 65-75 seconds.

16. The process of claim 1 wherein the once-parfried potato strips have a solids content of about 40-42% by weight.

17. The process of claim 1 wherein said freezing step comprises blast freezing the once-parfried potato strips at a temperature of about −15 to about −20° F.

18. The process of claim 1 further including the step of finish preparing the frozen potato strips by alternative methods selected from the group consisting essentially of finish frying, heating in a convection oven, and heating in an air impingement oven.

19. A process for parfrying and freezing potato strips capable of subsequent finish preparation by alternative methods including finish frying and oven heating, comprising the steps of:
blanching raw-cut potato strips in hot water or steam;
drying the blanched potato strips with a flow of warm air to achieve a strip weight loss on the order of about 7-12% and a strip solids content of about 24% to about 27% by weight;
partially rehydrating the dried potato strips by contacting the external surfaces thereof with a moisture-laden agent, the partially rehydrated potato strips exhibiting a weight gain attributable to the moisture-laden agent ranging from about 8% to about 19% by weight, and having a solids content of about 26% to about 29% by weight;
parfrying the rehydrated potato strips in hot oil for a single parfry step, the once-parfried strips having a solids content of about 40% to about 42% by weight; and
freezing the once-parfried potato strips.

20. The process of claim 19 further including the step of dipping the blanched potato strips into a dextrose dip solution prior to said drying step, the dextrose dip solution having a pH on the order of about 7.5-8.2.

21. The process of claim 19 wherein said rehydrating step comprises applying the moisture-laden agent by dipping or spraying.

22. The process of claim 19 wherein the moisture-laden agent comprises an aqueous batter.

23. The process of claim 19 wherein the moisture-laden agent comprises a clear-coat starch-based batter having a solids content of about 40% by weight.

24. The process of claim 19 wherein said parfrying step comprises parfrying the rehydrated potato strips in hot oil at a temperature of about 385° F. and a time of about 65-75 seconds.
